(19) United States
(12) Patent Application Publication
(10) Pub. No.: US 2014/0349534 A1
(43) Pub. Date: Nov. 27, 2014

(54) Multifunctional structure and method for its manufacture

(71) Applicant: MANIFATTURA DEL SEVESO SPA, BERGAMO (IT)

(72) Inventor: Franco Bologna, Bergamo (IT)

(73) Assignee: MANIFATTURA DEL SEVESO SPA, Bergamo (IT)

(21) Appl. No.: 14/369,182

(22) PCT Filed: Jan. 14, 2013
(86) PCT No.: PCT/IB2013/050341

§ 371 Date: Jun. 26, 2014

(30) Foreign Application Priority Data
Jan. 16, 2012 (IT) GE201A000005

(51) Int. Cl. D06N 3/00; B05D 3/00

(52) U.S. Cl. CPC D06N 3/0059; D06N 3/0011; B05D 3/007; D06N 2201/0254; D06N 2201/02; D06N 2209/065; D06N 2209/025; D06N 2209/103; D06N 2211/063
USPC 442/120; 427/243

(57) ABSTRACT

The present invention relates to a multifunctional structure having a load-bearing flexible porous support and a plurality of functionalizing fillers which are embedded in a resin matrix applied on the support such that at least a part of the resin penetrates into the fibrous support, however maintaining a portion of the thickness of the fibrous support not impregnated with the resin. The invention also relates to a method for manufacturing a structure according to the invention.

### TECHNICAL FIELD

The present invention relates to the field of building materials embedding functional agents, particularly it relates to a multilayer flexible structure intended for side (inner or outer) walls and/or more generally to the renovation and energy efficiency improvement of masonry structures of a building and to a method for manufacturing such structure.

### PRIOR ART

Different types of multilayer structures for such uses are generally known in the prior art, some of them comprise also a fibrous support with the aim of strengthening the structure and of embedding material having several functional properties such as for example thermal, acoustic insulation, fire resistance, antibacterial property. Generally materials for the renovation of façade or more generally of deteriorated masonry structures and materials for thermal or acoustic insulation of buildings or more generally intended to improve the energy efficiency thereof are further known.

More in detail, a common drawback in building industry, and in particular in interventions for reconstruction and retrofit of existing buildings, is the presence of façade, walls or more in general masonry structures that have been subjected to damages or degradation, for example due to a wrong management of humidity, to a wrong selection of materials, to a wrong preparation of the base, to the provision of movements or deformations of the structure that often are not predictable.

Typical effects of such cases result in the presence of cracks, fissures or crackles (for example due to very small movements of the masonry structure or to an excessive shrinkage of paints or plasters), which later can cause flacking and even partial peeling of the plaster with a serious aesthetic and functional damage.

For a sufficiently complete description of the prior art it is advantageous to make reference to specific categories of materials:
Locally applied reinforcement materials;
Mortars, plasters and special paints;
Rigid boards applied to the masonry, including also materials for the thermal and acoustic insulation of buildings and more generally intended for the improvement of their energy efficiency;
Flexible structures applied to the masonry;
Rigid structures placed at a certain distance from the masonry, including also structures similar to the so called “ventilated walls”.

As regards locally applied reinforcement materials: in the event of cracks or fissures, a conventional solution is single or multilayer flexible materials, often containing sheets or nonwoven fabric of polymer or mineral material, locally applied as strips or shapes.

These materials are characterized by high moduli of elasticity and a low deformability, and they serve for a reinforcement function by sealing the crack opening. A useful example is shown in US2006162845 to Bogard, wherein how to make a carbon fiber sheet intended for this aim is disclosed.

The sheet is applied to the crack so that warp and weft are perpendicular to the longitudinal direction of the crack, and it is smoothed with plaster.

Other similar examples can be found in DE20311693U1 to DICHTEC Gmbh, or in DE10140391 to Hugo.

The main drawback of this solution is that in many cases the movement originating the crack is due to very small structural movements, which cannot be suppressed by such localized reinforcements: thus as the material is low deformable, once it reaches the elastic limit it will break allowing the crack to travel outside.

Moreover, the untreated areas remain subjected to cracking risks in later times.

Other solutions provide to insert into the cracks specific materials able to fill the voids and to guarantee a sufficient stability to the conglomerate, subsequently smoothed with plaster, such as for example in CZ292734B6 to Ruf.

In this case, the drawbacks are the same as those previously described for locally applied sheets or nonwoven fabric, with in addition the reduction in the reinforcement effect and in the crack stopping.

As regards plasters and special paints: there have been on the market for a long time several examples of mortars, plasters, paints and/or similar cementitious, polymeric or composite based materials designed for solving the problems described above, such as for example plasters able to withstand a certain amount of movement of the base, high deformable elastomeric paints.

Another example is disclosed in U.S. Pat. No. 4,562,109 to Goodyear Tyre&Rubber, wherein there is disclosed the production of a coating composed of two layers: an innermost one contiguous to the base, composed of spherical beads bound together by a resin and able to absorb the movement of the crack edges without transmitting it to the outside, and an outer aesthetical finishing layer composed of conventional decorative paint.

This invention is useful for showing one of the possible approaches for treating cracks, which provides to interpose a deformable means able to limit the transmission of the underlying movements to the outside.

The main drawback of the described case is that these materials have to be accurately designed from case to case, since besides the drawback of cracks they have also to meet needs about transpiration, adhesion and durability: this leads to time-consuming, high costs and often it is not a guarantee of success since it depends on the conditions of each application.

Moreover the application is often time-consuming and not much easy, since the layer has to be left free to stabilize by eliminating the solvent, an operation that highly depends on the environmental conditions and therefore it is hard to be controlled.

Still other solutions are directed to provide elastomeric coatings or paints such as for example in EP665862B2 to RhonePolencChimie, wherein deformable additives such as for example elastomeric particles are inserted in the paint with cross-linking agents, thus resulting more advantageous as regards application easiness but less performing as regards movement absorption, since there is not an interposed means able to absorb deformations and the crack finds a lower resistance to transmission, due to the very small thickness of the paint layer (about 100 micron for a single coat).

On the contrary as regards rigid boards applied on the masonry there are provided several intervention examples based on rigid boards, which are directly applied on the deteriorated masonry and they serve as an homogeneous base upon which a new finishing is made, in addition to be thermal and/or acoustic insulating materials.

An example can be found in EP441295A1 to STO Poraver GMBH, wherein there is disclosed how to make a cementitious rigid panel with a thickness preferably of 8 mm, to be applied on a damaged wall by means of adhesive and dowels.

Dowels are fitted into holes and recesses suitably made and subsequently filled with cementitious bonding adhesive.

Then on this substrate it is possible to make several finishing.

Currently STO produces mineral fiber boards with a minimum thickness of 15 mm, to be used with the same modes in order to renovate deteriorated walls.

A second example can be found in US20040947186 to Saint Gobain Isover, wherein a rigid board is coupled to a flexible laminated article able to change the permeability depending on the relative humidity of the environment.

The material is one of the several products by Isover, intended for the thermal insulation of buildings and that are applied at the same manner by gluing, dowels, surface finishing. Another example can be found in DE202012102848U1 to Zierer-Fassaden, wherein the board is simply intended to cover the wall to be renovated and it is provided with a decorative finishing.

In all these cases, and in several further similar cases currently on the market, the main limits are due to the low deformability of the material and to the needs of mechanical fastening which is uncomfortable and results in thermal bridges in the structure.

In the case of cracks and fissures due to very small movements in the masonry structure, these solutions are not able to absorb the deformation, which leads to the yielding of the board and so damaging the outer finishing layer.

Moreover, above all in the case of acoustic or thermal insulators these solutions often are not applicable due to the high thicknesses, such as for example when one desires to preserve decorative elements of the façade, such as ribs, projections, labels, windowsills. With reference to flexible structures applied on the masonry there are several solutions based on flexible structures for renovating deteriorated façade.

An example is described in CA2200407C to GENCORP, wherein a flexible breathable membrane is placed between two nonwoven layers, wherein one side is placed on the façade to be covered by a binder and on the other it is possible to make a finishing.

The nonwoven structure provides cracks to be prevented.

A solution with even a decorative function is on the contrary described in KR1178434B1 to

Kim Yong Kook.

The renovation system is composed of an outer decorative layer with two supporting components, the last one of which is detachable such to allow it to be glued to the masonry wall.

Such layer is made of silicone resin and toluene.

A further example (EP1644594B1 to Barr) describes a multilayer system with an adhesive base and a nonwoven or fabric or mesh layer.

In the first case it has a thickness ranging from 2 to 5 mm, in the second case the spacing between strands ranges from 3 to 20 mm.

Moreover the application provides also the provision of a supporting metal or paper foil.

Once secured to the wall, the paint is given, whose setting is facilitated by the hollows of the multilayer.

With such product even the fractures in the buildings can be covered.

The main drawback of the described solutions is the fact that these materials are not able to improve the energy efficiency of the building, they just hold the cracks and cover the defects of the wall.

Moreover, in the cases when the fibrous material is a felt, a non optimal cohesion can derived and therefore the fraying due to the movement of the edges of the cracks, which therefore will tend to go on the surface.

Another example similar and provided with energy efficiency oriented functionality is the one described in US2003/0138594 to Lobovsky et al. wherein there is disclosed how to make an insulating material comprising a plurality of microspheres which are inserted in a supporting fibrous substrate.

This material is particularly useful for the above mentioned uses, however it has some drawbacks.

In this structure the insertion of the functional agents in the fibrous support occurs by shaking and by a medium represented by air.

In practice the spheres enter in the voids of the fibers of the fibrous support and after a suitable heating they expand thus remaining captured among the fibers of the support by mechanical anchorage between the spheres and the support.

On one hand this is quite satisfying as regards the thermal insulation, but on the other hand it has some limits as regards the fact that the coupling between microspheres and the fibrous support has to meet specific conditions, otherwise the mechanical anchorage between the two does not occur.

Moreover if the fibrous support is deformed such as for example it is the case of cracks or very small movements of the base, it tends to fray thus making useless even the insulating function. The choice of the couplings thus makes the selected solution of the functional agents limited, actually they being restricted only to the thermal insulation. Moreover the need of heating, useful for expanding the microspheres, leads to other limits as regards the manufacturing easiness and as regards the choice of the fibrous support, which has to be heated up to the temperature expanding the microspheres without being damaged.

Rigid structures placed at a certain distance from the masonry: a type of alternative solution provides real multilayer rigid structures to be made at a certain distance from the wall to be renovated, which thus is concealed while remaining protected. This installation type leads to make structures similar to ventilated walls, wherein often there is a load-bearing layer (usually made of metal) one or more layers with insulating function (rigid boards such as for example EPS or XPS or flexible boards like rock wools or the like) and one or more outer finishing layers, for example with plasters and paints or even tiles or other type of board with protective and decorative functions (plastic, painted metals, etc. . . . ). The main limits are due to the overall dimension of the structure, to the impossibility of preserving the details of the original façade, the high cost.

Alternative solutions for reducing the cost have been suggested, such as for example in DE10039257A1 to Vischer, wherein a textile covered by a protective layer is placed in tension before the exterior wall at a certain distance thereto, but technical limits due to overall dimensions and coverage are the same.

As regards multilayer structures on a fiber base comprising the impregnation of resins added with hollow microspheres or similar beads, even if not preferentially usable for applications directed to the renovation of façade or to the energy efficiency in building industry, it is suitable also to analyze some examples in different application fields.

A useful example can be found in WO2002012607 A3 to Freudenberg Wiestoffein wherein a structure based on a nonwoven fibrous support is described which is at least partially penetrated by a resin filled with microspheres for the thermal control filled with PhaseChangeMaterial.

The structure is produced by submerging the fibrous support in a bath of filled resin, followed by drying.

A similar example can be found in WO1995034609 A1 to Gateway Technology, wherein the article is substantially similar but it is made by coating or by transfer coupling.

Again, a similar example can be found in JP2003306672 to Mistubishi PaperMills.

The main drawbacks of these examples are due to the fact that the thermal insulation is obtained by PhaseChangeMaterials (PCMs) contained into the microspheres provided in the resin: PMCs are able to absorb thermal energy only within the small range of temperature wherein their phase transition occurs only for the time necessary for being completed, while actually they are not operative at high temperatures. Moreover they do not help in reducing the intrinsic conductivity of the material and so they do not change the ability of the article in transmitting the heat regardless of the temperature.

Another useful example can be found in U.S. Pat. No. 4,025,686A to Owens-Corning Fiberglass, wherein how to make a structure with a fibrous support at least partially penetrated by a resin or a foam filled with glass, ceramic or plastic microspheres.

The article is made by molding and solidification of the resin (probably cross-linking), by forcing a part of the resin to penetrate into the fibrous support while maintaining the microspheres inside the resin.

The article is thus mot much or not at all flexible due to the cross-linking of the resin, which however has to be performed in order to guarantee a suitable stability of the interface between fibrous support and the resin.

Moreover the material in the flexible condition, that is prior to the molding, has no penetration between the resin and the fibrous support, thus making the interface not stable.

Moreover the microspheres used do not provide a further increase in their diameter after being added to the resin, therefore the portion of the volume occupied by them in the resin, which defines the void level and therefore directly related to the thermal conductivity of the article, is constant.

The possible use of expanding plastic microspheres, however, could be of low success since the general high stiffness of the resins that solidify by cross-linking would not allow their volume to considerably increase, or even could tend to collapse them due to the shrinkage.

The use of rigid (glass, ceramic) microspheres could further lead to their breaking if the manufacturing process provides knife coating due to the high pressure of the knife on the receiving support, this is the reason why the present article is made by impregnation.

An example similar to the previous one of a structure comprising hollow microspheres impregnating a fibrous support and wherein a resin is introduced during the molding can be found in WO2006105814A1 to Spheretex, with the clear drawback that since the resin is inserted only after the fibrous support is expanded with non-expanding microspheres it cannot have a high void level, and therefore it cannot provide satisfying thermal conductivity values.

A further example to OwensCorningVeils (DE60103999T2) describes the manufacture of a structure intended for producing composite articles by molding, composed of nonwoven fibrous support wet impregnated with resin filled with expanding microspheres all along the thickness of the support, as it is clear from the appended drawings, which later can be consolidated.

Since a good behavior as a material for the renovation of façade having cracks or fissures is acceptable, and even if plausibly it has thermal and/or acoustic insulating properties, a clear drawback is the fact that it is impossible to prevent or limit the transfer to the outer layer of the deformation due to very small movements of the base.

Further examples of similar materials are found in JP2001090220 and in JP2002060685, both to Dainippon Printing, wherein coatings and/or primers composed of resins filled with microspheres are described, which can be used for covering or impregnating also fibrous supports and for obtaining a thermal insulation.

The main drawback of these solutions is the use of micro-beads with a predetermined diameter, that are not able to expand.

This leads to limits in maximizing the volume occupied by them, which is directly related, as mentioned, to the void of the resin and therefore to its thermal conductivity, as well as in maximizing the maximum amount of mixable micro-beads while maintaining an acceptably rheological resin for the following processes for the application on substrates (such as for example coating, impregnation, spraying or other processes).

### OBJECTS AND SUMMARY OF THE INVENTION

The object of the present invention is to overcome the prior art drawbacks.

Particularly, the object of the present invention is to provide a structure able to embed one or more functional agents and a method for manufacturing such structure.

Advantageously such method can be implemented with already existing equipment, such not to necessarily require producing and/or prearranging new apparatuses.

The structure according to the invention has high versatility characteristics and it is suitable for building applications, for example for ensuring the renovation of a façade or a masonry structure damaged by cracks, fissure, partial peeling or flaking of paint or plaster, while providing also a good thermal insulation of the building and/or acoustic and/or electromagnetic insulation or even fire-resistance ability.

The basic idea of the present invention is to provide a multifunctional structure comprising:
a load-bearing flexible porous support in the form of a sheet, provided with at least two larger outer faces substantially parallel and opposite to each other
a resin matrix applied on at least one face of said support
a plurality of functionalizing fillers embedded in said resin matrix
   wherein said resin matrix penetrates into said support for a thickness smaller than the distance between said outer faces of said support, such that at least one layer of said support is free from said resin matrix, such that said layer acts as a damping means for the deformations transmittable from the structure.

The diffusion medium of the functionalizing fillers therefore is the resin that guarantees that a part high enough of functionalizing fillers are embedded in the structure, preferably only in at least one surface layer of at least one of the two faces of the sheet-like structure. Especially the resin penetrates for a given thickness into the support, bringing the fillers with it and keeping them in place.

When the resin dries, it sets and thus it captures the functionalizing fillers, holding them: therefore the support acts as a reinforcement for the structure and the resin acts as a mechanical anchorage between the support and the functionalizing fillers, thus being the medium through which the fillers are transported and secured and guaranteeing the necessary stability of the filled resin/support interface by the partial penetration of the two elements.

A particularly advantageous embodiment of the structure provides the resin to be applied on the support by coating it: this allows both the thickness of the surface layer of the resin and the penetration depth of the resin in the support to be accurately controlled; this technique further allows to work in a wide range of viscosity of the resin in the fluid state, it being possible to use both very high and very low percentages of solid content in the resin.

The structure of the present invention allows many advantages to be obtained. Firstly the part of the support not impregnated with the filled resin causes the layer comprising filled resin not to be near a possible finishing layer applied on the opposite side: thus, the free support layer acts as a connecting means sufficiently labile not to transmit possible deformations suffered by the resin layer to the finishing layer on the opposite side. Moreover the ductile behavior the filled resin promotes the absorption of the deformations deriving from very small movements of the wall near to it, therefore helping in limiting their transmission towards the opposite face of the article.

Therefore the structure is useful for interventions renovating façade or more generally surfaces of masonry structures that have damages due to cracks, fissures, crackles, partial peeling of paint or plaster, small misalignments and generally other type of damage due to movements of portions of the façade, settling of the masonry structure or resulting from humidity damages.

Moreover, the non-impregnated layer of the porous support acts also as an air space, it being efficacious for exhibiting thermal or acoustic insulating functions and giving lightness and flexibility to the structure.

Moreover functionalizing fillers of any type can be selected thus obtaining products having a particular function or a single multilayer product having a plurality of functions, or even a single layer having a plurality of functions.

Different layers of the structure can be easily jointed together generating a single and continuous structure suitable for obtaining a variable thickness and multiple functional qualities depending on application requirements.

Moreover the structure made in this manner, as it is an assembly of resin, functionalizing resins and flexible porous support, has lightweight and flexibility properties while having the ability of being quickly finished by additional surface layers without the need of additional supporting systems such as plaster meshes.

Depending on needs the functionalizing fillers can be hollow micro-beads, containing void or gaseous fluid that can be expanded, or more in general solid bodies and with preferred shapes (spherical, elongated, cylindrical, polyhedric shapes or the like).

The structure of the invention is particularly useful for providing thermal insulation systems, thanks to the availability on the market of functionalizing fillers having very low thermal conductivity or that can influence the decrease of the thermal conductivity of the material where they are embedded in.

Among these types of applications a system for insulating inner walls is also shown since the present invention does not require the use of additional supporting structures or meshes for the finishing.

Moreover, thanks to the variable thickness and to its flexibility the structure of the present invention is particularly easy to be applied for complex geometries such as dimensional changes or not planar surfaces.

The use of specific functionalizing fillers can also lead to a “sound insulation” and “sound absorption” effect.

It is known that the sound insulation effect is obtained by increasing the density of the material while the sound absorption effect is obtained by dissipation of the acoustic wave in thermal energy by passing through porous and/or fibrous materials.

In the case of the present invention it is possible to select fillers having very high densities to make a sound insulating layer, and at the same time to select hollow fillers having dimensions and mechanical properties intended to enhance the dissipation effect and consequently to obtain a sound absorption layer.

The succession of sound insulating, sound absorbing and thermal insulating layers allows both the noise attenuation effect and the thermal insulation effect to be combined in a single multilayer element.

A further object of the present invention is a method for manufacturing a multifunctional structure according to the invention.

The possibility of easily mixing fillers having several different functionalizing properties with the resin advantageously allows a plurality of structures according to the invention to be made by using a common fabric coating plant, changing only the processing parameters and the types of fillers.

The preferred materials will be described below.

### BRIEF DESCRIPTION OF THE DRAWINGS

The invention will be described below with reference to non-limiting examples, provided by way of example and not as a limitation in the annexed drawings. These drawings show different aspects and embodiments of the present invention and, where appropriate, like structures, components, materials and/or elements in different figures are denoted by like reference numerals.

FIG. 1 is a section of a part of a structure according to the invention;

FIG. 2 is the structure of FIG. 1 with its parts separated;

FIG. 3 is an example of a variant of the structure of the previous figures;

FIGS. 4 and 5 are two variants of one of the components of the structure of the previous figures;

FIG. 6 is a variant comprising several superimposed structures of the present invention;

FIG. 7 is a plant for manufacturing the structure of the present invention.

### DETAILED DESCRIPTION OF THE INVENTION

While the invention is susceptible of various modifications and alternative forms, some relevant disclosed embodiments are shown in the drawings and will be described below in detail. It should be understood, however, that there is no intention to limit the invention to the specific embodiment disclosed, but, on the contrary, the intention of the invention is to cover all modifications, alternative forms, and equivalents falling within the scope of the invention as defined in the claims.

The use of “for example”, “etc.”, “or” indicates non-exclusive alternatives without limitation unless otherwise noted. The use of “including” means “including, but not limited to,” unless otherwise noted.

The use of the term “functionalized” structure can refer for example to improved “thermal insulating” or “sound insulating” or “sound absorbing” or “flame retardant” or “anti-electromagnetic” or “antibacterial” or “anti-mold” properties (or still any combination thereof), or similar functional properties given by embedding fillers in the resin and in the flexible fibrous support.

Where the description of the fillers goes in details, the functionality desired for the system will be defined.

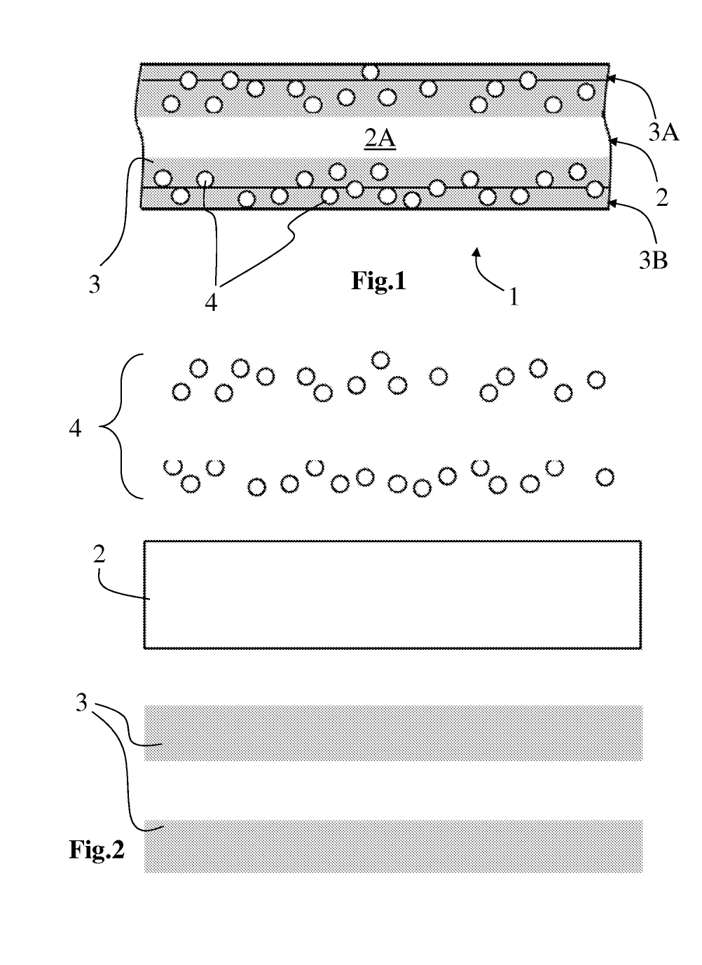

With reference to FIGS. 1 and 2 they show a basic example of a functionalized structure according to the invention, generally denoted with reference 1.

The functionalized structure 1 comprises a load bearing flexible porous support and a plurality of functionalizing fillers 4 that are embedded in a resin matrix 3 which penetrates for at least a certain thickness in the flexible porous support 2, leaving at least one portion of the thickness of the flexible porous support free from the penetration of the matrix of filled resin, such that such portion or layer acts as a damping means for the deformations transmittable from the structure 1 itself.

Such layer is denoted by the reference 2A in FIGS. 1 and 3 and with references 2A, 2B and 2C in FIG. 6 with reference to a plurality of structures 1, 1B and 1C.

With reference to the support it is completely generally a flexible porous support, more particularly a nonwoven fibrous support and still more particularly a felt. For convenience reference will be made below to solutions wherein said flexible porous support is a fibrous support or a felt, but generally it has to be understood that the following description comprises also solutions wherein more generally it is a different type of flexible porous support.

In substance we can say that the multifunctional structure 1 comprises
a load-bearing fibrous sheet-like support 2 provided with at least two larger outer faces substantially parallel and opposite to each other
a resin matrix 3 applied to said fibrous support 2
a plurality of functionalizing fillers 4 embedded in said resin matrix 3, which penetrates into the fibrous support for a thickness smaller than the distance between the outer faces of the fibrous support, such that at least one layer 2A of said fibrous support is free from said resin matrix, such to make a damping means or layer to reduce or prevent deformations transmitted between the two outer faces of the support.

In the preferred embodiment the resin 3 is coated in the fluid state with a specific viscosity on the fibrous support 2 and it penetrates therein for a certain thickness: however, the thickness and/or the conformation of the fibrous support 2 and/or the viscosity of the resin 3 and/or the processing parameters (speed, pressure, arrangement of machine apparatuses) are such that a penetration involving only the surface layers of the fibrous support occurs, by penetrating therein only for a certain amount at one or both the outer faces of the sheet-like fibrous support.

However it has to be noted that the resin 3 penetrates always for a certain distance in the fibrous support 2, taking the fillers 4 with it, which therefore also penetrate in the support 2; this avoids having only a surface adhesion of the resin 3 to the support 2, which would reduce the adhesion properties of the resin 3 to the support 2 of the structure 1.

More in details, and with reference also to FIG. 2, the several components of the structure 1 are shown as separated from each other for a better comprehension: the manufacturing method, necessary for obtaining the implementation of FIG. 1, as mentioned above, provides the resin 3, in fluid state with a specific viscosity, to be firstly filled with functionalizing fillers 4, then to be coated on the fibrous support 2, such to penetrate therein, and finally to be set by drying it, such to guarantee the functionalizing fillers 4 to be embedded into the resin matrix.

The process (or equivalently “method”) can be also repeated several times, on the same side or on both the sides (faces) of the fibrous support, allowing the performance of the product to be modulated as regards weight, functionality, flexibility.

The functionalized structure 1 preferably has a thin thickness, such to prevent the resin, once dried, to make it too much rigid: the structure 1 remains flexible, similarly to the fibrous support, even when the resin 3 sets.

Thus it is possible advantageously to match the structure 1 to different three-dimensional shapes of the application site, without causing cracks or failure in the support or in its components.

With reference thereto the structure 1 preferably has a thickness smaller than 2 cm, and still more preferably a thickness smaller than 0.8 cm.

Obviously the application of the resin 3 on the fabric leaves an outer layer visible, provided on each face of the fibrous support 2, shown in FIG. 1 with references 3A and 3B. The layer provided between 3A and 3B is important since the resin in the fluid state, as already described, is coated with a specific viscosity on the fabric and it penetrates therein up to a certain thickness but it does not reach its central part or central layer 2A.

The Applicant has found that the non-complete incorporation of the resin 3 in the fibrous support 2 allows an unexpected combination of advantages: it allows not only the structure to be more light, but at the same time it allows the thermal insulating properties to be maximized, and a real damping layer 2A to be generated (composed of the non-impregnated portion of the fibrous support) able to reduce or suppress the transmission of deformations between the opposite faces of the support.

Advantageously the ratio of the thickness of the intermediate layer 2A where the resin is not provided to the final thickness of the article ranges from 5% to 80%, preferably from 5% to 50%, and still more preferably from 10% to 30%.

Obviously solutions, as the one shown in FIG. 6, are possible wherein a plurality of structures 1, 1B, 1C are superimposed such to form a single structure. By analyzing in details the components of the functionalized structure 1, they can change depending on the needs.

Even in this case for each structure the intermediate layer free from the resin 2A, 2B, 2C is provided.

The identification of the properties of the materials, and their application ranges, result from the materials characterization activity by the Applicant, where the main optimization parameters are manufacturability, cost, increased functionality, flexibility.

The resin 2, advantageously is for example a foamable acrylic resin or a polyurethane foamable resin or more generally a polymer foamable one.

Even in this case, as regards the support it is preferably a flexible porous support, more particularly a nonwoven fibrous structure and still more particularly a felt.

A first type of particularly useful felt is made of polypropylene fibers preferably fire resistant one.

A second type of particularly useful felt is made of polyester fibers preferably fire resistant ones.

Advantageously the polypropylene or polyester fibers are thermal calendered, with a basis weight ranging from 100 g/m² to 1000 g/m².

As an alternative the polypropylene or polyester fibers are not thermal calendered, with a basis weight ranging from 100 g/m² to 1000 g/m².

Again as an alternative, polypropylene or polyester fibers are thermal calendered on one side.

As an alternative the fibers are fiber glass or they are also made of synthetic, mineral or metal material or also a combination of the fibers described above.

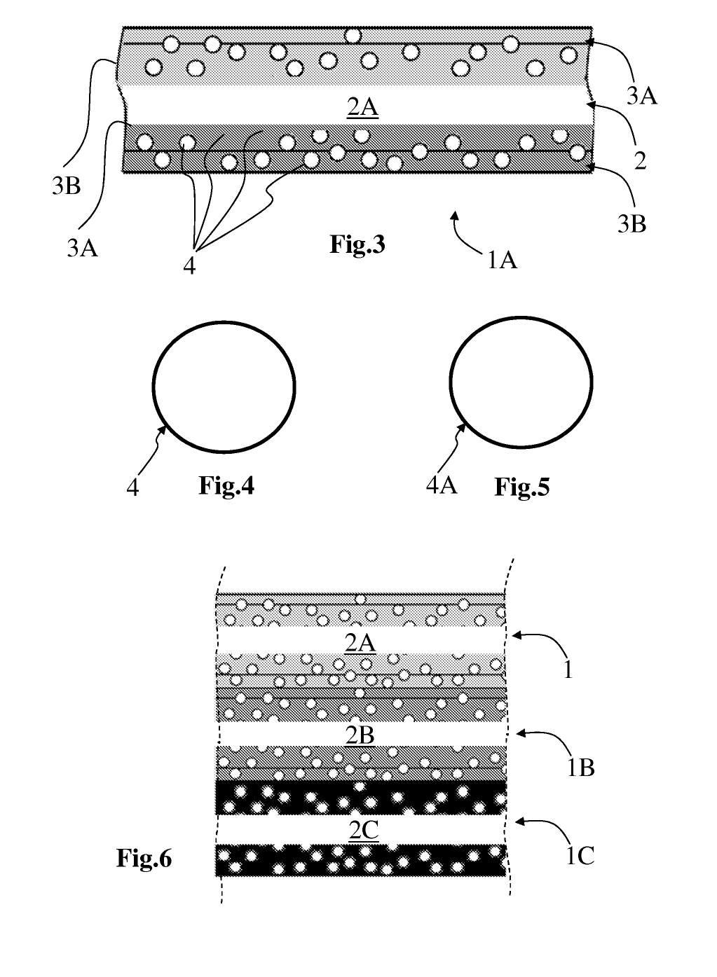

As regards the functionalizing fillers 4, a first example of thermal insulating fillers is shown in FIG. 4: each filler 4 in this case is a thermoplastic hollow sphere pre-expanded by a hydrocarbon that expands when heated.

The term pre-expanded means that the size of the sphere (or equivalently a solid having also another shape) does not increase when drying the resin, but it remains substantially unchanged.

As an alternative the functionalizing fillers 4 are thermoplastic hollow spheres to be expanded filled with an hydrocarbon that expands when heated or any other gaseous compound that expands if heated, thus causing each sphere to correspondingly expand.

In this case the functionalizing fillers are intended to expand preferably in the step drying the resin by heating.

Thus an optimal final diameter of the sphere is obtained, since the sphere expands when the resin dries by heating such to obtain at the same time a strong mechanical fastening.

Thus a further advantage is that the partial collapse to which the pre-expanded spheres can be subjected in the drying step is avoided, due to the fact that the heating in specific cases could generate a softening of the sphere walls not supported by the inner pressure of the expanding gaseous compound; it has to be noted that such collapse could lead to a non optimal functionality because the final volume of the sphere would be reduced. Preferably said thermal insulating pre-expanded fillers have a diameter from 30 to 50 micron and/or a solid content from 15%±2% by weight and/or a real density of 36±3 kg/m³ and/or a real volume of 4.2±0.45 l/kg.

Preferably said thermal insulating fillers in the non-expanded configuration have a diameter ranging from 10 to 16 micron and/or a density lower than or equal to 25 kg/m³.

As a further alternative the functionalizing fillers 4 are solid or hollow particles with different dimensions and materials depending on the desired functionalization.

As regards on the contrary the percentage of functionalizing fillers 4 in the resin 2, the Applicant has found that the best results are achieved when the functionalizing fillers 4 are filled in the resin in percentages ranging from 5% to 45% by volume, where the best results in terms of compromise between functional capacity and ease in manufacturing and installation are identified for 15%±5% by volume.

Another particularly useful material for the functionalizing fillers 4 intended to obtain a thermal insulation is the expanded perlite having a diameter ranging from 0 to 1 mm.

Still another alternative provides the functionalizing fillers 4 intended to obtain a thermal insulation to be as the one shown in FIG. 5, that is solid spheres substantially with the same dimensions and materials described for the hollow spheres.

Still another alternative provides the functionalizing fillers 4 intended to obtain acoustic insulation to be polyhedrons or bodies of revolution, as small cylinders or the like provided with a very high density.

With reference now to FIG. 3, it shows still another alternative of the structure, denoted by 1A, of the present invention.

In this alternative a single fibrous support layer 2 is impregnated with two different resins 3A and 3B that impregnate it, however leaving the central layer 2A free which therefore is composed of non-impregnated fibrous support, as in the previous case.

In this example the two resins 3A and 3B are the matrix only for one type of functionalizing fillers 4, but generally functionalizing fillers of different type for each resin 3A and 3B could be provided.

Again generally it is also provided for the same type of resin 3 to be the matrix for two or more different type of beads 4, for example of the type described above.

As regards the method (or process) for making the structure 1 (and by analogy even the other types mentioned above) in one general embodiment it comprises a preliminary step for applying a resin filled with functionalizing fillers to a fibrous support and a subsequent step heating and drying the filled resin.

In a preferred embodiment the resin is applied by coating and the method comprises the following steps:

a. mixing a resin 2 in fluid state with a plurality of functionalizing fillers 4 such to obtain a filled resin,
b. coating the filled resin on the inner or outer side of a fibrous support till reaching a substantially complete adhesion of all the resin,
c. heating and drying the filled resin spread on said fibrous support,
d. coating the filled resin on the previously not coated side of the fibrous support till reaching a substantially complete adhesion of all the resin,
e. heating and drying the filled resin coated on said fibrous support.

Advantageously for transport reasons the structure 1 made in this manner is wound into rolls.

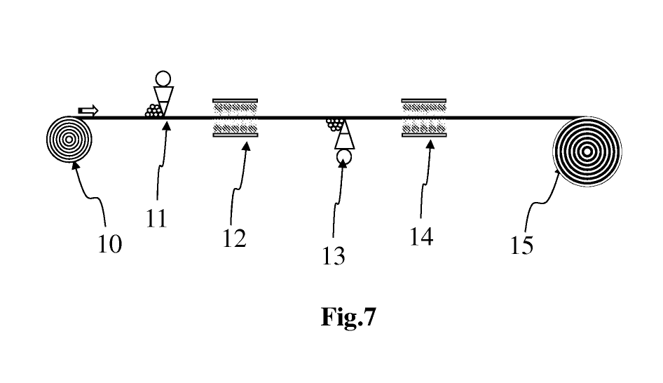

An example of such manufacturing process is synthetically shown in FIG. 7 wherein a plant for manufacturing the functionalized structure according to the present invention is shown, which comprises:

a. a decoiler 10 for a roll of fibrous support,
b. a first application station 11, where a first face of said fibrous support is coated with functionalizing fillers 4 and a resin 3 in the viscous condition,
c. a drying oven 12, wherein the fibrous support 2 coated with the filled resin and still in the fluid state with a specific viscosity passes, for a time sufficient to cause it to be heated and dried as well as to cause the functionalizing fillers contained in the resin to be possibly expanded,
d. a second application station 13, wherein a second face of said fibrous support is coated with functionalizing fillers 4 and a resin 3 in the fluid state with a specific viscosity,
e. a second drying oven 14, wherein the fibrous support 2 coated with the filled resin on the second side of the fibrous support and still in the fluid state with a specific viscosity passes, for a time sufficient to cause it to be heated and dried as well as to cause the functionalizing fillers contained in the resin to be possibly expanded, such to obtain the structure 1 described above.

Depending on the configuration to be made, the described process can be repeated several times, or alternatively limited to the first coating station 11 and to the first passage in the drying oven 12.

Optionally the structure obtained in this manner is wound in a coiler roll 15.

It has to be noted that contemporaneously with the drying or desiccation of the resin the functionalizing fillers also expand, with the advantages described above.

Later, in the event of installation on an outer wall of a masonry structure for the renovation of the façade and/or thermal acoustic insulation and/or use of possible other functionalities, the following steps are provided to be accomplished:

1. Coating an adhesive on a masonry surface,
2. Applying the functionalized structure,
3. Optionally mechanically fastening the structure to the masonry surface: if on the same masonry surface there are applied a plurality of adjacent insulating structures it is further possible to grout the joints of adjacent insulating structures,
4. Optionally applying a supporting mesh
5. Smoothing and plastering,
6. Possible painting

In the case of installation on inner wall of a masonry structure for thermal acoustic insulation, the following steps are provided to be accomplished:

1. Coating an adhesive on a masonry surface,
2. Applying the functionalized structure,
3. Optionally mechanically fastening the structure to the masonry surface: if on the same masonry surface there are applied a plurality of adjacent insulating structures it is further possible to grout the joints of adjacent insulating structures,
4. Optionally smoothing and plastering,
5. Optionally possible painting.

Thus the objects mentioned above are achieved.

It has to be noted, incidentally, that on the finished structure 1 the marks that denote that it has been obtained by a resin coating step are usually visible: such marks are typically the presence of a selvage free from functionalizing material, that is edges of a specific width upon which the laying of the resin on the support structure is completely or partially absent.

Such marks can also comprise the presence of a preferred direction in laying the filled resin, visible to the naked eye and typically associated to the coating processing, especially if the coating is made by air knife or counterpiece with roller or other supporting structure.

### Application Example 1

The structure of the invention is useful for providing systems for renovating a façade or a masonry structure damaged by cracks, fissures, paint or plaster partial peeling or flaking, while providing also a good thermal and/or acoustic insulation since, in opposition to prior art, the present invention contemporaneously is able of:

a. limiting or suppressing the transfer of deformations from the inner surface to the outer surface, where the inner surface is the one in contact with the masonry structure upon which the application is made and the outer surface is the surface upon which subsequently the possible finishing is made, by means of the ductility of the resin layer and to the provision of a non-impregnated inner layer of the fibrous support that acts like a labile interposed means,
b. providing thermal insulating functionalities, thanks to the high void level of the resin obtained by hollow fillers expanding by the provision of a non-impregnated inner layer of the fibrous support that acts like a hollow space,
c. providing acoustic insulating functionalities, thanks to the structure rich in hollows as described above,
d. not requiring the use of additional supporting meshes or structures,
e. having properties of flexibility, adaptability and variable thickness useful even for complex geometries, as well as the ability of being easily shaped by scissors, cutters or similar tools.

In this case the structure preferably has the following specifications:
the resin is acrylic foamable, particularly it being an acrylic acetonitrile and acrylic copolymer with pH ranging from 8 to 10, solids content of 60%±2%, viscosity ranging from 10,000 to 15,000 cps,
the resin contains further additives, among which anti-filming, antifoaming ones, anti-tack fillers,
the fibrous support is a felt of thermal calendered polyester fibers, with a basis weight of 250±10%/g/m², average tensile strength of 10±13% kN/m, average elongation at maximum load >60%, water permeability normal to the plane of 50±30% l/m²s, opening size of 75±30% μm;
fillers have a diameter ranging from 10 to 16 micron, and/or a density lower than or equal to 25 kg/m³.
fillers are filled with a hydrocarbon or another gaseous compound able to expand if heated, and which is completely or partially ejected at the end of the expansion;
fillers expand at temperatures ranging from 80 to 135° C.,
thermal insulating fillers are embedded in the resin for 15%±5% by volume.

The finished product is obtained by air double knife coating of the filled resin on the upper face with a speed higher than 15 m/min, rapid oven drying at a temperature ranging from 90 to 130° C., air double knife coating of the filled resin on the lower face of the fabric with a speed lower than 15 m/min, further rapid oven drying at a temperature higher than 130° C. and final winding.

The product has a surface density of 700±5% g/m², and the non-impregnated felt layer has a thickness of about 0.75±50% mm.

The product is then laid by mechanical adhesion to the wall, the subsequent laying of a sealant between possible parallel elements and the laying of a final protecting and aesthetic layer. The main advantages of such configuration are related to the possibility of obtaining several insulating layers depending on the flexibility and insulating needs; the removal of the reinforcement mesh, which is typically used before laying the finishing layer.

### Application Example 2

In a second preferred application example, the structure has characteristics similar to the application example 1 but the fibrous support is a felt of mainly virgin or top quality polypropylene, with a basis weight of 250±10% g/m², average tensile strength of 13±13% kN/m, average elongation at maximum load >50%, water permeability normal to the plane of 70±30% 1/m²s, opening size of 55±30% μm.

The final product further has a ultimate tensile strength higher than 1.5 N/mm², percentage elongation at break higher than 120%, and it can be classed as a breathable membrane (resistance to the passage of vapor Sa lower than 0.25 m).

Going back to a comparison with prior art, necessary for better understanding the advantages of the present invention, below a summarizing table is shown from which the advantages of the present invention are clear.

| | | Ultimate tensile | Thermal | Typical |
|---|---|---|---|---|
| Material | Elongation % | strength | conductivity | thickness |
| Structure of the | >100% | >1.5 N/mm² | <0.032 W/mK | 5 mm |
| invention | | | | |
| Locally applied | 1-2% | 3400 N/mm² | Higher or equal | <1 mm |
| reinforcement | (Ref. | (Ref. | to a standard | |
| materials (anti- | US20060162845) | US20060162845) | system of | |
| crack meshes) | | | mortar, plaster | |
| | | | and paint since | |
| | | | it has the same | |
| | | | material but in | |
| | | | addition with a | |
| | | | reinforcement | |
| | | | that, if made of | |
| | | | carbon, has a | |
| | | | higher thermal | |
| | | | conductivity | |
| Mortars, | From 10-30% | >1.5 N/mm² | ~0.1 W/mK | <0.5 mm |
| plasters and | | | | |
| special paints | | | | |
| Rigid boards | it being a rigid | n.a. | 0.036 | From 0.8 cm to |
| applied on the | material, | | | 20 cm generally |
| masonry | generally <50% | | | >10 cm |
| Rigid structures | n.a. | n.a | On average a | 40 cm plus the |
| placed at a | | | ceramic | dimensions of |
| certain distance | | | ventilated wall | the hollow |
| from the | | | is equal to 0.320 | space |
| masonry | | | W/m2K | |

The table shows how the structure of the invention contemporaneously has a series of technical functionalities, essential for the good operation of the invention and which have optimal characteristics and/or performances for the final application.

It has to be noted how such characteristics and/or performances not all are provided in prior art materials, which have either one or the other of them, or alternatively none of them, or alternatively the same functionalities but with unsatisfying characteristics and/or performances with reference to the good operation of the final application.

The invention claimed is:

1. Multifunctional structure (1, 1A, IB, IC) comprising
a load-bearing flexible porous support (2) shaped as a sheet, provided with at least two larger outer faces substantially parallel and opposite to each other;
a resin matrix (3, 3A,3B) applied on at least one face of said support (2); and
a plurality of functionalizing fillers (4, 4A) embedded in said resin matrix (3,3A,3B),
wherein said resin matrix (3,3A,3B) penetrates into said support for a thickness smaller than a distance between said outer faces of said support (2), such that at least one layer (2A, 2B, 2C) of said support (2) is free from said resin matrix, such that said layer (2A,2B,2C) acts as a damping element for deformations transmittable from the structure (1, 1A, 1B, 1C).

2. Multifunctional structure (1, 1A, IB, IC) according to claim 1, wherein said flexible porous support is a nonwoven fibrous support.

3. Multifunctional structure (1, 1A, IB, IC) according to claim 2, wherein said nonwoven fibrous support is a felt.

4. Multifunctional structure (1, 1A, IB, IC) according to claim 1, wherein said resin matrix (3,3A,3B) is applied by coating on said fibrous support (2).

5. Multifunctional structure (1, 1A, IB, IC) according to claim 1, wherein said resin matrix (3,3A,3B) is selected from the group consisting of acrylic resins, polyurethane resins, and polymer resins.

6. Multifunctional structure (1, 1A, IB, IC) according to claim 3, wherein said felt comprises as fibers selected from the groups consisting of one or more of polypropylene fibers, polyester fibers, a blend of polypropylene fibers and polyester fibers with natural, synthetic or mineral fibers ranging from 35% to 90%.

7. Multifunctional structure (1, 1A, IB, IC) according to claim 6, wherein said felt is a felt of polypropylene fibers, said polypropylene fibers being alternatively:
thermal calendered polypropylene fibers, with a basis weight ranging from 100 g/m² to 1000 g/m²,
non-thermal calendered polypropylene fibers, with a basis weight ranging from 100 g/m² to 1000 g/m², or
polypropylene fibers thermal calendered on one side.

8. Multifunctional structure (1, 1A, IB, IC) according claim 6, wherein said felt is a felt of polyester fibers, said polyester fibers being:
thermal calendered polyester fibers, with a basis weight ranging from 100 g/m² to 1000 g/m²,
not thermal calendered polyester fibers, with a basis weight ranging from 100 g/m² to 1000 g/m², or
polyester fibers thermal calendered on one side.

9. Multifunctional structure (1, 1A, IB, 1C) according to claim 1, wherein said functionalizing fillers (4) are hollow solids.

10. Multifunctional structure (1, 1A, IB, 1C) according to claim 9, wherein said functionalizing fillers (4) are full of air.

11. Multifunctional structure (1, 1A, IB, 1C) according to claim 9, wherein said functionalizing fillers (4) are filled with a hydrocarbon configured to expand when heated such to cause each filler to expand.

12. Multifunctional structure (1, 1A, IB, 1C) according to claim 9, wherein said functionalizing fillers (4) have one or more of a diameter from 30 to 50 micron, a solid content from 15%±2% by weight, a density of 36±3 kg/m³, or a volume of 4.2±0.45 l/kg.

13. Multifunctional structure (1, 1A, IB, 1C) according to claim 9, wherein said functionalizing fillers (4, 4A) are filled with resin of said resin matrix (2) in percentage ranging from 5% to 45% by volume.

14. Method for manufacturing a multifunctional structure (1, 1A, IB, 1C) according to claim 1, comprising:
a preliminary step of applying a resin filled with functionalizing fillers to a porous support, and
a subsequent step of heating and drying the filled resin.

15. Method according to claim 14, further comprising a step of expanding said functionalizing fillers in said resin matrix contemporaneously with said heating step.

16. Multifunctional structure (1, 1A, IB, 1C) according to claim 9, wherein said functionalizing fillers (4) have one or more of a diameter ranging from 10 to 16 micron or a density lower than or equal to 25 kg/m³.
